(19) United States
(12) Patent Application Publication
(10) Pub. No.: US 2010/0292971 A1
(43) Pub. Date: Nov. 18, 2010

(54) METHOD AND TESTING DEVICE FOR TESTING A TRAFFIC-CONTROL SYSTEM

(75) Inventor: Thomas Sachse, Bruckmuhl (DE)

Correspondence Address: LERNER GREENBERG STEMER LLP, P O BOX 2480, HOLLYWOOD, FL, 33022-2480, US

(73) Assignee: Siemens Aktiengesellschaft, Munchen (DE)

(21) Appl. No.: 12/810,882

(22) PCT Filed: Nov. 6, 2008
(86) PCT No.: PCT/EP2008/065072

§ 371 Date: Jun. 28, 2010

(30) Foreign Application Priority Data
Dec. 27, 2007 (DE) 10 2007 062 741.8

(51) Int. Cl. G06G 7/66; G06F 17/18

(52) U.S. Cl. 703/6; 702/181

(57) ABSTRACT

In a method and a testing device for testing a traffic-control system, a traffic situation is simulated and traffic simulation data are generated on the basis of control data of the traffic-control system. The data are transmitted to the traffic-control system as input data. At the same time behavior probability distributions of traffic participants are ascertained based on at least part of the control data and the simulation of the traffic situation takes place using the behavior probability distributions.

The present invention relates to a method and a testing device for testing a traffic control system. In particular, it relates to a method or a testing device in which a traffic situation is simulated, traffic situation data are derived therefrom and said traffic situation data are fed back into the traffic control system as input data. The method or the testing device therefore forms a closed control loop with the traffic control system, for which reason the method can also be called “closed-loop simulation”.

Traffic control systems of the more complex type are used today on busy roads, specifically on highways and in heavily frequented routes inside of built up areas, such as ring roads and access roads in large towns. They usually have a multiplicity of traffic control actuators. These are understood to mean all traffic regulation instruments which forward traffic regulations and traffic advice to road users by means of signaling. In particular, they thus include road signs, which indicate such regulations and advice variably or statically, but also instruments such as traffic radio or traffic regulation by means of remote influence on navigation systems.

Significant differences arise in this context between application inside of built up areas and application outside of built up areas. Urban traffic control systems primarily involve controlling light signal installations by means of an urban traffic management system in order to render effective and manage traffic flows inside of built up areas. By contrast, traffic control systems outside of built up areas, specifically highway traffic control systems, usually have a much greater number of different actuators for controlling traffic flows. These include, inter alia, variable traffic regulation indicators, which are able to present speed limits, restrictions on overtaking, speed requirements, safety warnings, weather information and other indicators relevant to the route and/or surroundings.

Furthermore, traffic management systems inside of and outside of built up areas often have direction arrows which can close off or open up particular lanes to traffic or can indicate a necessary change of lane. In addition, it is possible to signpost diversions and indicate queue hazards, for which reason they may comprise not only permanently installed display panels but also mobile indicators.

Traffic control systems may therefore be in the form of highly complex systems. It is correspondingly complicated to ascertain the operability and effectiveness of traffic control systems. To date, this has been able to be done effectively only by means of a test during operation, with the crucial drawback that changes to the traffic control system were therefore relatively difficult to perform and even serious shortcomings on the system generally did not become apparent until too late, namely after it had been implemented.

In order to counter these problems in advance, it is possible to use simulation systems of the type cited at the outset. However, these are currently based on model data which take account of only a relatively restricted set of influencing factors and can reach the limits of their performance when there are a large number of actuators. The consequence may be simulation results which are not precise enough and hence are unrealistic. Ultimately, the operability of traffic control systems can be assessed in advance only crudely using a simulation system, and it is then still necessary to perform a test during operation, which has the drawbacks mentioned previously.

It is therefore an object of the present invention to provide an improved alternative to the previous methods and testing devices.

The invention achieves this object by means of a method for testing a traffic control system, in which control data from the traffic control system are taken as a basis for simulating a traffic situation and in this context producing traffic situation data which are transferred to the traffic control system as input data, wherein at least one portion of the control data is taken as a basis for ascertaining behavior probability distributions for road users and the traffic situation is simulated using the behavior probability distributions. That is to say that different control data are assigned behavior probability distributions for the probability of the road users reacting to the relevant control data item, for example a prescribed maximum speed or a lane recommendation.

In this context, traffic control systems are understood to mean traffic management and/or traffic guidance systems. They usually comprise at least one control center, which may also be in the form of a simple switchbox, for example, and a collection of actuators, which regulate the traffic in a traffic region on the basis of control data which are sent from said center. A traffic control system may also comprise a plurality of control centers which may also be associated with one another in a plurality of hierarchy levels, for example in the form of traffic guidance centers operating equivalently beside one another which are all linked to a traffic management center located one organization level higher. Furthermore, traffic control systems usually have traffic sensors which capture traffic situations by means of sensors and generate measurement data, usually in electronic form, therefrom and provide said data for the control center.

By way of example, these include induction loops beneath the road surface for measuring the volume of traffic at a particular measurement point, video, infrared and other optical monitoring systems, position systems such as GPS or Galileo and radio information systems, for example on the basis of radiofrequency identification (RFID) systems. Just as for the traffic itself, it is possible to use sensors to ascertain traffic parametric data such as weather influences or the quality of the road surface. Sensors in the broadest sense are also understood to mean simply human observations, for example from traffic helicopters or on the basis of reports from road users.

The traffic situation data produced in the simulation according to the invention correspond to data which have ordinarily been acquired by traffic sensors in the traffic control system. The simulation thus uses the control data from the traffic control system which is to be tested to generate the most accurate possible depiction of a traffic situation and derives traffic situation data therefrom. These are fed back to the traffic control system as input data.

The control data are understood to be the signals from the traffic control system, wherein these signals would be used, in real operation, to control traffic control actuators. Within the context of the invention, they are instead used as input data for the simulation. In principle, any type of control data can be assigned behavior probability distributions. In particular, however, it is appropriate within the context of the invention to take account of control data which influence the behavior probability distributions of road users to a significant degree, but do not determine it practically 100%. An example of the latter type of control data are data for a light signal installation circuit. In this case, it can be assumed that the probability of road users disregarding a red signal is almost negligible. Behavior probability distributions are therefore preferably used for control data which, although having a very direct influence on traffic behavior, allow the expectation of a certain variation in behavior. By way of example, this includes hazard reports, on the basis of which road users usually restrict their speed, but not uniformly. There is thus a change in their traffic behavior, which can be represented as an alteration in a behavior curve.

Control data, which influence the behavior probability distributions only slightly, or the influence of which on the behavior probability distributions of road users varies greatly on the basis of further constraints, are taken into account only secondarily. By way of example, simple information signs for attractions at the edge of the road influence road users far less than road signs or road display boards, according to experience. It is thus possible to discern a varying level of efficiency in different actuators which it is possible to incorporate into the simulation as a basis for calculation.

The control data to which behavior probability distributions are assigned therefore advantageously include parameters for traffic control actuators which indicate behavior requirements and/or prohibitions. In line with two alternative or complementary developments of this embodiment, the control data may comprise parameters for traffic control actuators which regulate the maximum speed of traffic flows and parameters for traffic control actuators which regulate the course of the route for the traffic flows.

Traffic control by means of behavior requirements and prohibitions, particularly by means of maximum speed provisions and by means of route guidance systems (for example by means of arrows which open up or close lanes), are particularly important influencing factors for the traffic behavior of road users. In this respect, it is of particular advantage to take into account when simulating traffic control situations. If a single instance or all of these parameters are taken into account, it can be assumed with a high level of probability that the accuracy of the traffic simulation has already exceeded a value from which it is possible to assume very realistic test conditions.

With the simulation on the basis of behavior probability distributions for road users, the invention is introducing statistical methods whose data foundations are usually based on many years of practical experience from a series of measurements. In this context, behavior probability distributions relate to particular reference quantities, which in turn influence the traffic situation, such as the speed of vehicles. They can be plotted in a probability curve. They provide an indication of the probability of a particular, randomly selected vehicle travelling at a particular speed, for example. Using the random principle, it is possible to take the behavior probability distribution as a basis for assigning speeds to vehicles. This makes it possible to simulate very accurately in all road users what individual traffic sensors would capture during real operation of the traffic control system. The method therefore has, inter alia, the advantage that it is of dynamic design and, on the basis of empirically collected data and stochastic empirical values, can ensure the most accurate possible depiction of real traffic situations.

The object is also achieved by a testing device for testing a traffic control system, which has at least:
a data acceptance interface for accepting control data from the traffic control system,
a traffic situation simulation unit for simulating a traffic situation on the basis of the control data with a traffic simulation data generation unit for generating traffic simulation data on the basis of a simulation result,
a data transfer interface for traffic simulation data to the traffic control system. In this case, in line with the invention, the testing device comprises a behavior probability ascertainment unit for ascertaining behavior probability distributions for road users, and the traffic situation simulation unit is in the form such that the simulation is performed using the behavior probability distributions.

In such a testing device, the traffic situation simulation unit and also the traffic situation data generation unit and the behavior probability ascertainment unit may either be in the form of standalone individual components in terms of hardware and/or software or may be integrated together within an electronic processor chip. It can be implemented fully or in part on a computer in the traffic control system. Furthermore, the data acceptance interface and the data transfer interface may be either in the form of hardware in the form of input and output sockets or wireless interfaces for an appliance or in the form of software or a combination of hardware and software components. Interfaces, for example in the form of pure software interfaces, can also directly accept data from a traffic control system, for example if the testing device is arranged on the same computer as the traffic control system. The interfaces can also be in combined form together as an input/output interface.

Designing the testing device in the form of software has the advantage of a rapid and inexpensive implementation. For this reason, the method according to the invention is performed preferably using a computer program product which can be loaded directly into a processor of a computer device, with program code means, in order to perform all the steps of such a method.

Further particularly advantageous refinements and developments of the invention can also be found in the dependent claims and in the description below. In this case, the testing device according to the invention may also have been developed in accordance with the dependent claims relating to the method.

Advantageously, the traffic situation is simulated on the basis of further input quantities and/or factors in addition to the control data from the traffic control system. These include both quantities and factors which are constant in the long term and variable quantities and factors.

By way of example, the quantities which are constant in the long term can be considered to be the practical circumstances of the road, the presence of natural traffic obstacles or the cultural surroundings of the respective country. Variable quantities relate to traffic disruptions, the trends in traffic density, the time of day, weather influences and environmental influences, for example. As a result of such further relevant input quantities and/or factors being taken into account in the simulation process, the traffic control system is provided with a comprehensive database for the simulation which it can take as a basis for designing a differentiated simulation image. For such simulation, quantities which are constant in the long term, such as the practical circumstances or the cultural surroundings, can be incorporated into the simulation as a type of basic quantity, whereas for the traffic control system to determine a particular traffic scenario and a traffic control sequence which is to be derived therefrom the variable quantities are usually redefined for every simulation.

One advantageous development of this embodiment provides for the control data to be assigned a behavior probability distribution on the basis of the further input quantities and/or factors. The additional parameters explained in more detail above are thus also incorporated directly into the determination of the behavior probability distributions and are therefore advantageously provided with a sufficient weighting for the simulation and for the extraction of the traffic situation data, which is dependent on the behavior probability distributions. By way of example, it is thus possible to take account of the fact that maximum speed requirements are usually more readily observed in very poor weather than in fine weather.

With particular preference, the control data and/or further input quantities and/or factors and/or combinations thereof are assigned behavior probability distributions from a database system. This means that an association database, in which, by way of example, matrix-esquely determined control data or input quantities or particular combinations of these control data and input quantities are assigned behavior probability distributions, for example in the form of probability curves, is provided in or in conjunction with the behavior probability ascertainment unit. During operation, the behavior probability ascertainment unit searches this database or matrix for the respective constellation of input quantities or control data or combinations thereof which comes closest to a defined database statement, and supplies the behavior probability distribution associated with said database statement to the traffic situation simulation unit. The effect achieved by such database-based association of constellations with behavior probability distributions is, inter alia advantageously, that during operation the system is not burdened with unnecessary calculation tasks for behavior probability distributions, but rather can resort to previously generated, empirically and systematically acquired data relating to behavior probability distributions. This makes the system and the method more effective and, specifically when there are a large number of influencing factors taken into account, still keeps them operational.

In line with one particularly preferred embodiment of the invention, particular control parameter types are assigned particular basic behavior probability curves, and the basic behavior probability curves are altered on the basis of a control parameter value and/or on the basis of further parameters in line with a prescribed rule.

Usually, a behavior probability distribution alters when control data change not only in respect of a curve parameter for the probability curve but also in respect of a plurality of such parameters. If the admissible maximum speed were raised from 100 km/h to 160 km/h, for example, then the probability curve would not shift in the same shape from a speed range around 100 km/h toward a speed range around 160 km/h. On the contrary, it can be expected that for a speed limit of 100 km/h numerous road users would tend to drive at slightly more than this maximum speed and therefore a high probability is obtained in the region of approximately 100 km/h. By contrast, for a limit of 160 km/h it can be assumed that numerous road users wish to drive at less than this speed and therefore a more even curve is obtained which is more likely to be elongate and less bulbous than the previously mentioned curve, and that a significantly smaller number of road users will exceed the admissible maximum speed of 160 km/h. This can be explained by the fact that the desired speed of many road users, that is to say the speed at which they wish to travel under the conditions provided by vehicle and road, tends to be below the indicated admissible maximum speed, which means that the road users simply aim for this desired speed and at any rate do not see any reason to risk a speed violation.

In order to depict the numerous alterations in the behavior probability curves when only one control parameter value is varied, that is to say a control data item, for example, the embodiment thus uses basic behavior probability curves and prescribed rules for altering these curves. The effect advantageously achieved, inter alia, by this is that a variable control parameter already has a basis for calculation which then needs to be varied only to a more limited extent depending on the control parameter value in order to arrive at the desired specific behavior probability curve. This makes more effective use of the capacity of the testing device. The advantage of this embodiment becomes particularly important when a distinction is drawn between requirements and prohibitions for the control parameter types. In the case of requirements, the basic behavior probability curve will tend to assume a broader expansion form than in the case of prohibitions. If there is a speed requirement of 130 km/h for example, then fewer road users will keep to this than if 130 km/h is an admissible maximum speed. It can therefore be expected that more road users also drive much faster than 130 km/h, whereas in the case of the maximum speed the outliers upwards keep within narrow bounds.

This embodiment can be applied on its own or in combination with the database-based embodiment presented above.

In line with one particularly preferred embodiment of the invention, the simulation is a microscopic simulation which simulates the behavior of individual road users and/or of individual small groups of road users, wherein on the basis of the behavior probability distributions, each of the road users and/or each of the small groups is assigned a behavior in relation to individual control data.

To assist understanding, the concept of the small group of road users is defined as a group of road users in a traffic region, which does not include the sum total of all road users but rather is in a microscopic context in relation to one another. By way of example, these vehicles may be from a particular vehicle classification or vehicles which serve a particular purpose, such as delivery vehicles or vehicles from a vehicle fleet, or vehicles which run in a particular subsection of a traffic region. As a basis for vehicle classification, it is possible to use what is known as 8+1 classification, for example: this distinguishes between motorcycles, cars, delivery trucks, cars with trailers, HGVs, HGVs with trailers, articulated trucks, buses and other motor vehicles. Other types of classification are also possible, however.

In the combination of a microscopic simulation with the ascertainment of behavior probability distributions, which then relate to microunits such as road users or small groups in a traffic region, the invention reveals its advantages in a quite particular manner. This is because the use of behavior probabilities as a basis for simulating the behavior of the individual units allows traffic flows to be simulated several degrees more accurately. Added to this is the fact that behavior probability distributions allow such a large number of traffic influencing factors to be taken into account that the micro simulation itself is also raised to a new level of quality.

In line with one advantageous development of this embodiment, the individual road users and/or the individual small groups are respectively allocated individual behavior probability distributions. On the basis of these individual behavior probability distributions, the respective road users or small groups are then assigned a specific traffic behavior for a particular situation.

This means that, at a microview level, statistical and stochastic methods are again used in order to assign particular behaviors to road users or small groups and to define the probability of a behavior in a particular situation. Inter alia, this results in the advantage of the again much more in-depth detailing, on the basis of which the system according to the invention provides, on the basis of this advantageous development, a barely surpassable contact with reality in the simulation.

In line with one particularly preferred embodiment of the invention, the traffic simulation is performed for a limited traffic region, for example for a route section or an urban area. In line with particularly advantageous developments, this traffic region comprises traffic routes which are designed for high speeds and/or it comprises traffic routes which are predominantly outside of built up areas. The simulation within a defined traffic region advantageously ensures that a large number of influencing factors and control data need to be captured only for this traffic region, and additional outside influences from other traffic regions can be disregarded in the simulation. This increases particularly the effectiveness when testing the traffic control system, since with unrestricted volumes of data it might be possible both for the calculation capacities of the system to reach their limits and for the weighting of influencing quantities to be very easily assessed incorrectly. For the vehicles entering and leaving the traffic region, it is possible to assume blanket values on the basis of statistical captures. Similarly, real values can be adopted from any traffic control systems which may already have been installed or simulated for adjoining traffic regions.

Particularly for traffic routes which are designed for high speeds, that is to say traffic routes which, on the basis of their original or actual determination, are designed for speeds >=60 km/h, and specifically for traffic routes which are predominantly outside of built up areas, the invention reveals its advantages quite particularly, since the influence of external influencing factors on what is happening in the traffic increases with speed, and since, by way of example, specific influencing factors, such as the weather or the regulation of speed, are much more significant in regions outside of built up areas than in regions inside of built up areas. Furthermore, according to experience, if it is possible to drive at relatively high speeds, the behavior differences of various road users are, despite traffic control measures, reckoned to be greater at least in absolute values than in a region in which it is only possible to drive at relatively low speeds. A quite particularly advantageous effect therefore unfolds on high-speed routes such as expressways, specifically multilane expressways, and highways and on junctionless or grade-separated routes.

The invention develops its effect in a particularly advantageous manner if the level of detailing for the behavior of probability distributions is chosen on the basis of the available computer capacity in the testing device and/or the available database, particularly in terms of control data. The aim of a corresponding restriction in the level of detailing is to achieve fast and effective simulation with, at the same time, the greatest possible depth of detailing for the basis for the simulation.

The invention is explained in more detail again below using exemplary embodiments with reference to the appended figures. In this context, components which are the same have been provided with identical reference numerals in the various figures, in which:

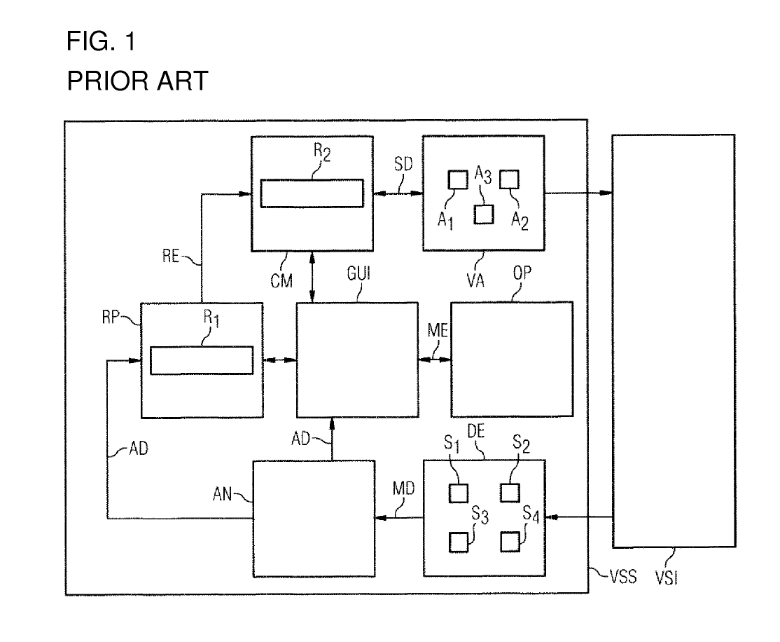

FIG. 1 shows a simplified block diagram of a traffic control system based on the prior art to explain the process of traffic control,

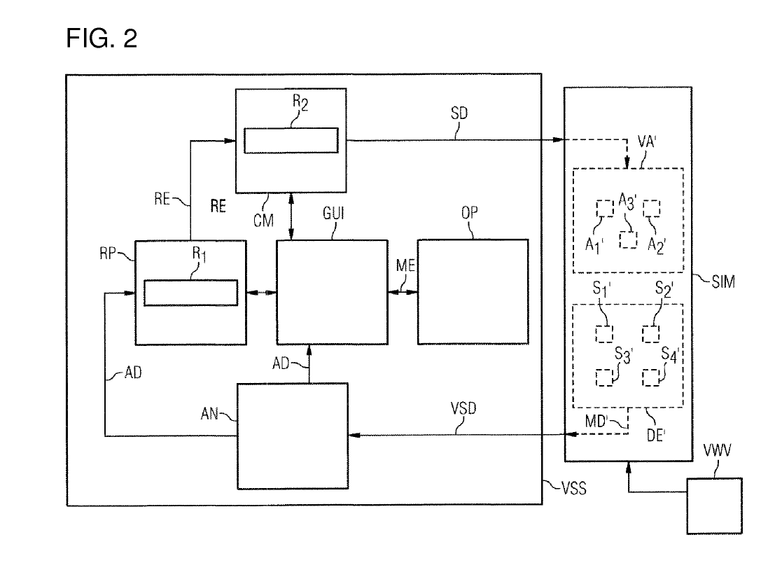

FIG. 2 shows a simplified block diagram of a traffic control system with an exemplary embodiment of a testing device according to the invention to explain a possible process for a method according to the invention for testing the traffic control system,

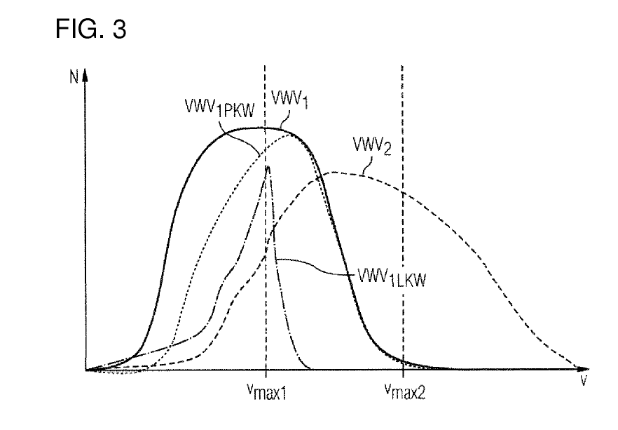

FIG. 3 shows an exemplary graph of behavior probability distributions for various traffic control data and for various types of transport,

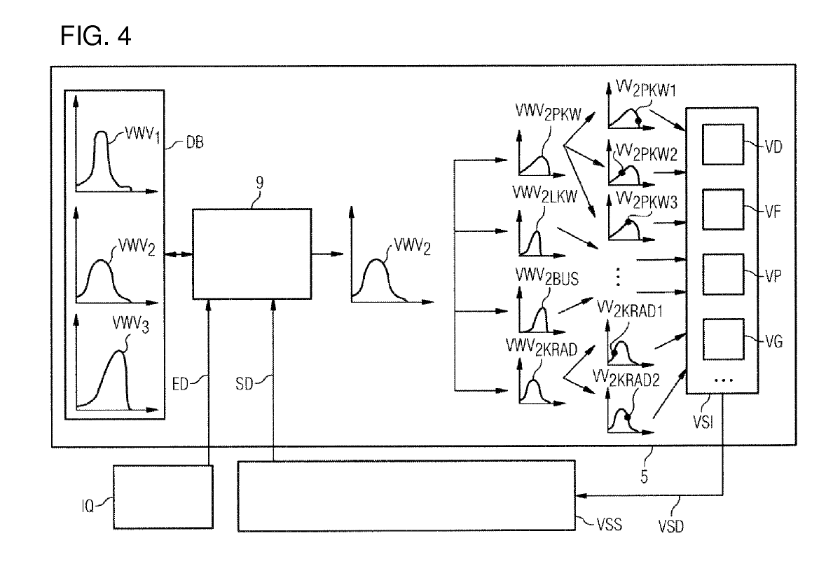

FIG. 4 shows a detailed flowchart for a simulation within the context of the method according to the invention, and

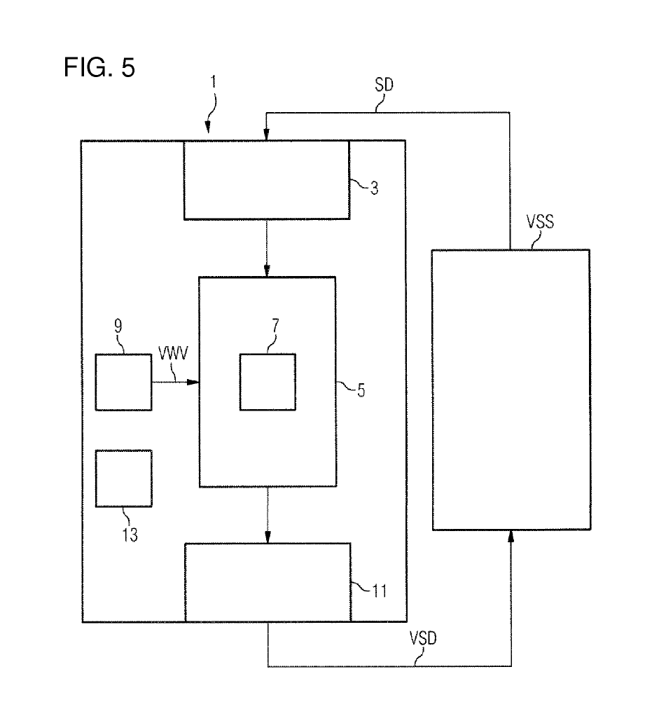

FIG. 5 shows a schematic block diagram of a testing device according to the invention.

FIG. 1 shows a traffic control system VSS having the following components: a detection system DE, an analysis and prediction module AN, a response plan module RP, a control model module CM, a traffic actuator system VA and a graphical user interface GUI.

The detection system DE comprises a plurality of sensors S₁, S₂, S₃, S₄ which are set up at various locations in the traffic region. By way of example, these are video surveillance cameras, infrared cameras, RFID receiver systems and induction loops. Similarly, the traffic actuator system VA comprises a plurality of actuators A₁, A₂, A₃, for example in the form of variable speed indicators, variably adaptable direction arrows for roads and indicators for warnings in a traffic region, e.g. a highway section.

Operation of the traffic control system VSS results in the following basic process: the current traffic situation VSI in the traffic region is captured by means of the sensors S₁, S₂, S₃, S₄ in the detection system DE. The sensors S₁, S₂, S₃, S₄ generate measurement data MD in the form of raw data or conditioned raw data, which are forwarded to the analysis and prediction module AN. Raw data may be, by way of example, simple signals for each vehicle that drives over the sensor region of an induction loop or is detected by a sensor in another way. In this example, conditioned raw data would be information about the traffic density, which information is based on the formation of a value by a circuit by counting the aforementioned signals over a measurement time. The analysis and prediction module AN takes the measurement data MD and generates analysis and prediction data AD, which are forwarded firstly to the graphical user interface GUI for graphical representation and secondly to the response plan module RP. On this basis, the response plan module RP uses stored rules R₁ to compile a response plan input RE, and forwards the latter to the control model module CM. The rules R₁ and/or the response plan input RE can be displayed and possibly also altered by an operator OP using the graphical user interface GUI. In addition, the control model module CM optionally receives input commands ME from an operator OP via the graphical user interface GUI. On the basis of the response plan input RE and the input commands ME and using stored rules R₂, the control model module CM generates control data SD for the traffic actuator system VA or for the actuators A₁, A₂, A₃ thereof. The graphical user interface GUI communicates both with the response plan module RP and with the control model module CM and conditions the information or data therefrom graphically. Using the actuators A₁, A₂, A₃ of the traffic actuator system VA, the traffic control system VSS exerts a controlling influence on the traffic situation VSI in the traffic region. A closed control loop is obtained, since the altered traffic situation VSI is again fed back via the detection system DE to the traffic control system VSS.

FIG. 2 shows the same traffic control system VSS, with the difference that the detection system DE and the traffic actuator system VA are not used in this case. Instead, the control data SD from the control model module CM are input into a simulation SIM, in which actuators A₁′, A₂′, A₃′ in a virtual traffic actuator system VA′ are controlled virtually as appropriate. The current result of a simulation is then respectively a virtual traffic situation, which produces traffic simulation data VSD which correspond to virtual measurement data MD′ from a virtual detection system DE′ with sensors S₁′, S₂′, S₃′, S₄′. The traffic simulation data VSD are input directly into the analysis and prediction module AN. In line with the invention, the simulation is in this case performed on the basis of behavior probability distributions VWV.

Graphs of such behavior probability distributions VWV₁, VWV₂ are shown in FIG. 3, inter alia, for the speed behavior of road users. FIG. 3 plots the probability N (in arbitrary units) of a road user traveling at a particular speed. In this context, a first behavior probability distribution VWV₁ relates to the behavior probability of all road users in a traffic region on the premise of a first admissible maximum speed Vₘₐₓ₁ and a second behavior probability distribution VWV₂ relates to the behavior probability of all road users on the premise of a second admissible maximum speed Vₘₐₓ₂. Vₘₐₓ₂ is greater than Vₘₐₓ₁. In this example, the curves of the two behavior probability distributions VWV₁, VWV₂ vary significantly in shape, which corresponds to reality in most cases. This is related to the fact that different behavior patterns emerge for a relatively high admissible maximum speed than for a relatively low one. In relation to the first behavior probability distribution VWV₁, two transport-type-related behavior probability distributions VWV_{1PKW} and VWV_{1LKW} are shown for closer consideration, said distributions relating to the behavior of car drivers and HGV drivers. Since HGVs are usually equipped with a tachograph, HGV drivers, when viewed statistically, adhere to admissible maximum speeds—apart from a minor transgression in a region which is still exempt—far more conscientiously than car drivers. This produces a maximum for the HGV-related curves VWV_{1LKW} shortly above the admissible maximum speed Vₘₐₓ₁, whereas the bandwidth of the behavior probability distribution VWV_{1PKW} for car drivers is greater on both sides of the maximum speed Vₘₐₓ₁.

Such behavior probability distributions for control parameters like the speed limit and in detail broken down into individual categories of road users form the basis for the simulation SIM shown in FIG. 2.

A method flow according to the invention is shown in detail in FIG. 4. A traffic situation simulation unit 5 is supplied with control data SD from a traffic control system VSS to be tested and optionally additional input data ED such as weather information from further information sources IQ. A behavior probability distribution ascertainment unit 9 selects from a database DB, which contains behavior probability distributions VWV₁, VWV₂, VWV₃, the behavior probability distribution VWV₂ which corresponds to the control data SD and to the additional input data ED. From this behavior probability distribution VWV₂, it assigns respective vehicle-category-related behavior probability distributions VWV_{2PKW}, VWV_{2LKW}, VWV_{2BUS}, VWV_{2KRAD} to the vehicle categories: cars PKW, heavy goods vehicles LKW, buses BUS and motorcycles KRAD. From this, a respective traffic behavior VV_{2PKW1, VV}_{2PKW2}, VV_{2 PKW3}, VV_{2KRAD1}, VV_{2 KRAD2} is allocated for individual vehicles on the basis of the random principle. In the simulation, this results in a simulated traffic situation VSI which is manifested in the current traffic density VD, the traffic flow VF, traffic problems VP and the average speed of the traffic VG, for example. On the basis of this traffic situation VSI, the traffic situation simulation unit 5 generates traffic simulation data VSD, in line with the measurement data MD from the traffic control system VSS, which it feeds back into the traffic control system in order to close the control loop.

The proper functioning and quality of the traffic control system VSS are proven if the simulation SIM shows for different control data SD or the additional input data ED that no significant traffic disruptions are generated but rather, on the contrary, traffic flows and emissions tend to be optimized and traffic risks tend to be reduced.

FIG. 5 schematically shows the design of a testing device 1 in accordance with the invention. It has a data acceptance interface 3, a traffic situation simulation unit 5, a behavior probability distribution ascertainment unit 9, an analysis unit 13 and a data transfer interface 11. The traffic situation simulation unit 5 contains a traffic simulation data generation unit 7. The testing device 1 receives control data SDL from a traffic control system VSS via the data acceptance interface 3. The traffic situation simulation unit 5 takes behavior probability distributions VWV ascertained by the behavior probability distribution ascertainment unit 9 as a basis for simulating a traffic situation, and this is used by the traffic simulation data generation unit 7 to generate traffic simulation data VSD. Said traffic simulation data VSD are routed back to the traffic control system VSS via the data transfer interface 11. The analysis unit 13 analyzes the quality of the traffic control of the traffic control system VSS on the basis of the aforementioned criteria and thus provides the test result for the traffic control system VSS.

In conclusion, it will once again be pointed out that the method described in detail above and the illustrated testing device are merely exemplary embodiments which a person skilled in the art can modify in a wide variety of ways without departing from the scope of the invention. Furthermore, the use of the indefinite articles “a” and “an” does not prevent the relevant features from also being present in a plurality. In addition, “modules” and “units” may comprise one or more components, including components arranged in physically distributed form.

1-13. (canceled)

14. A method for testing a traffic control system, the method which comprises:
providing control data in the traffic control system, the control data being suitable for simulating a traffic situation and for generating traffic simulation data;
taking at least one portion of the control data as a basis for ascertaining behavior probability distributions for traffic participants and simulating the traffic situation using the behavior probability distributions, and generating traffic simulation data; and
transferring the traffic simulation data to the traffic control system as input data.

15. The method according to claim 14, which comprises simulating the traffic situation on the basis of further input quantities and/or input factors in addition to the control data in the traffic control system.

16. The method according to claim 15, which comprises allocating a behavior probability distribution to the control data on the basis of the further input quantities and/or input factors.

17. The method according to claim 16, wherein the control data and/or further input quantities and/or input factors and/or combinations thereof are allocated behavior probability distributions from a database system.

18. The method according to claim 14, wherein the control data are allocated behavior probability distributions from a database system.

19. The method according to claim 14, which comprises allocating particular control parameter types to particular basic behavior probability curves, and altering the basic behavior probability curves on the basis of a control parameter value and/or on the basis of further parameters in line with a prescribed rule.

20. The method according to claim 14, wherein a simulation is a microscopic simulation that simulates a behavior of individual traffic participants and/or individual small groups of traffic participants, and wherein the behavior probability distributions are taken as a basis for allocating each of the traffic participants and/or each of the small groups a behavior in relation to individual control data.

21. The method according to claim 20, which comprises respectively allocating the individual traffic participants and/or the individual small groups individual behavior probability distributions.

22. The method according to claim 14, wherein the control data comprise parameters for particular traffic control actuators in the traffic control system indicating behavior requirements and/or prohibitions.

23. The method according to claim 22, wherein the control data comprise parameters for particular traffic control actuators in the traffic control system regulating a maximum speed of traffic flows.

24. The method according to claim 22, wherein the control data comprise parameters for particular traffic control actuators in the traffic control system which regulate a course of traffic flows.

25. The method according to claim 14, which comprises carrying out a simulation for a particular traffic region.

26. The method according to claim 25, wherein the particular traffic regions are traffic routes designed for high speeds and/or traffic routes outside of highly populated areas.

27. A testing device for testing a traffic control system, comprising:
a data input interface for accepting control data from the traffic control system;
a traffic situation simulation unit connected to receive the control data from said data input interface;
a behavior probability ascertainment unit for ascertaining behavior probability distributions for traffic participants;
said traffic situation simulation unit including a traffic simulation data generation unit and simulating a traffic situation on the basis of the control data with the simulation using the behavior probability distributions, and for generating traffic simulation data on the basis of a simulation result; and
a data transfer interface for transferring the traffic simulation data to the traffic control system.

28. A computer program product to be loaded directly into a processor in a computer device, the computer program product including program code which, when loaded into the computer device, performs the steps of the method according to claim 14.
